(19) United States
(12) Patent Application Publication
(10) Pub. No.: US 2009/0228942 A1
(43) Pub. Date: Sep. 10, 2009

(54) SYSTEM AND A METHOD FOR MANAGING AUDIOVISUAL PROGRAMS IN A TELECOMMUNICATIONS NETWORK

(75) Inventors: Herve Brelivet, Saint-Quay Perros (FR); Patrick Fleming, Paris (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, PARIS (FR)

(21) Appl. No.: 12/293,867

(22) PCT Filed: Mar. 12, 2007
(86) PCT No.: PCT/FR07/50911

§ 371 Date: Jan. 28, 2009

(30) Foreign Application Priority Data
Mar. 22, 2006 (FR) 0650988

(51) Int. Cl. H04N 7/173

(52) U.S. Cl. 725/109

(57) ABSTRACT

This system (20, 40, 50, 60) manages audiovisual programs (CH1, CH2) in a telecommunications network, each program being broadcast by a source (30) to receivers (10) that are subscribed to a broadcast group. It includes: means (60) for interpreting a sequence of audiovisual programs programmed by a user of a receiver in the form of a succession of commands to change program, a command to change program being conditional on a preceding program in said sequence ending; means (40) for detecting a predetermined event (EV) corresponding to the start of the first program in the sequence, or to the end of one of said programs in the sequence; and means (20) for sending said receiver (10), after said event is detected, a first message (ZAP) adapted to trigger sending by said receiver (10) to said management system (20) of a first request (AB) to subscribe to a broadcast group for the first program in the sequence, or the program in said sequence following the program for which the end has been detected.

### BACKGROUND OF THE INVENTION

The field of the invention is that of broadcasting audiovisual contents in IP (Internet Protocol) networks.

In the present document, the expression “audiovisual content” refers to content associated with the IPTV (Internet Protocol Television) service and all associated services, in particular VoD (Video on Demand), TVoD (Television on Demand), NTS (Network-based Time Shifting), and NPVR (Network-based Personal Video Recorder).

The term “streaming” refers to the method of broadcasting a multimedia stream (video, TV, etc.) from a server to a client in an IP network. Among other things, streaming enables “live” (real-time) broadcasting of audiovisual programs in unicast mode or in multicast mode.

In multicast mode a single copy of each multimedia stream is sent to each branch of the network. This relies on constructing a multicast tree between the source and the receiver terminals.

In solutions that broadcast audiovisual content in an IP network, the operator enables subscribers to view a plurality of audiovisual programs. To optimize the use of network resources, not all programs are broadcast continuously to each client. All clients watching the same audiovisual program broadcast by the same source form a subscriber group defined by the source/program pair. Consequently, a client wishing to receive a new audiovisual program (in other words to change channel or “zap”) has to unsubscribe from the group corresponding to the current program and subscribe to the group corresponding to the new program.

These subscription and unsubscription operations are generally carried out using the Internet Group Management Protocol (IGMP).

Historically, to manage live broadcasting, equipment installed on the user premises has recorded the audiovisual program being viewed, starting from a point that moves with time.

The person skilled in the art calls this process time shifting.

More recently, some operators and equipment manufacturers have deployed network-based time-shifting solutions.

To be more precise, a server of the network implements a centralized version of the role of the subscriber premises equipment and user commands are sent to this server, for example using the Real Time Streaming Protocol (RTSP).

The RTSP controls the distribution of multimedia streams in an IP network in unicast mode. It is an application level protocol offering the functions of a remote recorder (play, pause, fast forward, fast rewind, stop, etc.).

A receiver terminal seeking to use one of these functions contacts the streaming server using the RTSP.

In response, the server broadcasts the multimedia streams providing the service, separately from RTSP exchanges, using the streaming protocol, for example the Real Time Protocol (RTP) or the MPEG2-TS (Transport Stream) Protocol.

For example, if the client wishes to pause the current audiovisual program (using the PAUSE function), an associated RTSP message is sent to the server, which starts to record the audiovisual program the client is watching.

At present, and for all types of television broadcasting, viewers are restricted by the strict synchronism of television channels. Thus a viewer cannot watch different programs transmitted simultaneously on different channels, even if all the transmissions are potentially of interest. At best, one transmission can be viewed while a second transmission is being recorded to be viewed later. If there are more than two simultaneous transmissions, the viewer has no solution.

The synchronized transmission of channels also prevents television viewers from watching the whole of two programs transmitted at times that overlap.

Furthermore, the increasing number of channels offered to viewers obliges them to “zap” constantly, if they are to be able to view all transmissions of interest. It is rare for all programs potentially of interest to a user to be transmitted on the same channel. A viewer who fails to change channel at the end of a transmission, runs the risk of missing another interesting program transmitted on another channel.

It is therefore necessary for the viewer to pay close attention to the program guide and to zap from one channel to another, which proves irksome.

### OBJECT AND SUMMARY OF THE INVENTION

The invention relates to a system for managing audiovisual programs in a telecommunications network, each program being broadcast by a source to receivers that are subscribed to a broadcast group.

This system includes:
means for interpreting a sequence of audiovisual programs programmed by a user of a receiver in the form of a succession of commands to change program, a command to change program being conditional on a preceding program in said sequence ending;
means for detecting a predetermined event corresponding to the start of the first program in the sequence, or to the end of one of said programs in the sequence; and
means for sending said receiver, after said event is detected, a first message adapted to trigger sending by said receiver to said management system of a first request to subscribe to a broadcast group for the first program in the sequence, or the program in said sequence following the program for which the end has been detected.

In a correlated way, the invention relates to a method of managing audiovisual programs in a telecommunications network, each program being broadcast by a source to receivers that are subscribed to a broadcast group.

This method includes:
a step of interpreting a sequence of audiovisual programs programmed by a user of a receiver in the form of a succession of commands to change program, a command to change program being conditional on a preceding program in said sequence ending;
a step of detecting a predetermined event corresponding to the start of the first program in the sequence, or to the end of one of said programs in the sequence; and
a step of sending said receiver, after said event is detected, a message adapted to trigger sending by said receiver of a first request to subscribe to a broadcast group for the first program in the sequence, or the program in said sequence following the program for which the end has been detected.

Thus the invention proposes a novel and inventive approach to managing audiovisual programs that a user can view.

Using the invention, and by logging onto an interactive portal, for example, a client user can program a sequence of programs (football match, news, film, etc.) to be viewed over a particular time period, for example an entire evening.

The portal then interprets the programming entered by the client as a succession of zaps, each conditional on the previous transmission in the sequence entered by the client coming to an end.

The portal can then transmit these zapping instructions to a server, which executes them at the required time.

To be more precise, on detecting a predetermined event, for example the beginning of the first transmission in the sequence, the invention sends the receiver a message that automatically triggers sending by the receiver of a request to subscribe to a broadcast group for the audiovisual program that is starting.

Similarly, on detecting the end of an audiovisual program of the sequence preprogrammed by the client, the invention sends the receiver a message that automatically triggers the sending by the receiver of a request to subscribe to a broadcast group of the next audiovisual program in the sequence.

The invention therefore overcomes the drawback of the prior art because the user no longer needs to change channel as and when programs start and end. It suffices to program in advance the sequence of broadcasts to be watched and channel changing is then automatic, without the user having to do anything.

In one particular embodiment, the management system and the management method of the invention are adapted to store an audiovisual program broadcast in a network in a sliding time window. In particular, the management system and the management method of the invention are adapted, on detection of the start of one of the programs in the sequence selected by the user, to start recording that program if the end of the preceding program in the sequence has not yet been detected.

The invention therefore provides a solution to the prior art problem of the client being restricted by the strict synchronism of TV channels and being unable to view different transmissions broadcast simultaneously on different channels, even if all those transmissions are potentially of interest.

By means of the invention, the client can watch live a first broadcast (for example the news) and then watch off-line a second broadcast (for example a football match) which started before the end of the first broadcast, and so on for a predetermined sequence of broadcasts that the user has preprogrammed.

In one particular embodiment, the management system and method of the invention are adapted, after detecting the end of a program in the sequence whose transmission time at least partly overlaps the next program in the sequence, to send the receiver a second message adapted to trigger sending by the receiver to the management system of a second request to set up a communications channel with the management system to obtain, in that channel, at least part of the audiovisual program recorded by the system, corresponding to the program following the program in the sequence the end of which has been detected.

This kind of message naturally replaces the message described above that triggers sending of a request to subscribe to a broadcast group for the program following the program in the sequence the end of which has been detected. It is used if two successive broadcasts in the sequence programmed by the user have overlapping broadcast times, in contrast to the first message referred to, which is used if the broadcast times of the successive transmissions do not overlap.

By means of this feature, after the end of a program has been detected by the management system of the invention, a user can receive off-line an audiovisual program that is no longer being broadcast in multicast mode, but in unicast mode, on a logical communications channel set up to the receiver of that user.

In one particular embodiment, the management system and the management method of the invention include, before the message is sent to a receiver, a step of the receiver or the user of the receiver confirming the subscription to the new broadcast group, in other words the change of channel.

This can be confirmed explicitly by reception of a command coming from the receiver or implicitly by the absence of reception of a command during a predetermined time period.

In one particular embodiment of the invention, the receiver sends requests to the management system using the RTSP.

In one particular embodiment of the invention, the management system of the invention sends messages to the receiver in the form of an SNMP (Simple Network Management Protocol) frame encapsulating an IGMP command.

Thus, on reception of the SNMP frame, the receiver automatically executes the IGMP command contained in the frame and subscribing the receiver to the new broadcast group.

In one particular embodiment, the various steps of the audiovisual program management method are determined by computer program instructions.

Consequently, the invention is also directed to a computer program on an information medium and adapted to be executed in an audiovisual program management device, or more generally in a computer, the program including instructions adapted to execute the steps of an audiovisual program management method as described above.

That program can use any programming language and take the form of source code, object code or an intermediate code between source code and object code, such as a partially compiled form, or any other desirable form.

The invention is also directed to a computer-readable information medium containing instructions of a computer program as referred to above.

The information medium can be any entity or device capable of storing the program. For example, the medium can include storage means, such as a ROM, for example a CD ROM or a microelectronic circuit ROM, or magnetic storage means, for example a diskette (floppy disk) or a hard disk.

Moreover, the information medium can be a transmissible medium such as an electrical or optical signal, which can be routed via an electrical or optical cable, by radio or by other means. The program of the invention can in particular be downloaded over an Internet-type network.

Alternatively, the information medium can be an integrated circuit into which the program is incorporated, the circuit being adapted to execute the method in question or to be used in its execution.

### BRIEF DESCRIPTION OF THE DRAWINGS

Other features and advantages of the present invention emerge from the description given below, with reference to the appended drawings, which show one non-limiting embodiment. In the figures:

FIG. 1 represents a management system of the invention and the main steps of a management method of the invention;

FIG. 2 represents a configuration table used in the FIG. 1 embodiment; and

FIG. 3 represents a preferred embodiment of a computer according to the invention.

### DETAILED DESCRIPTION OF EMBODIMENTS

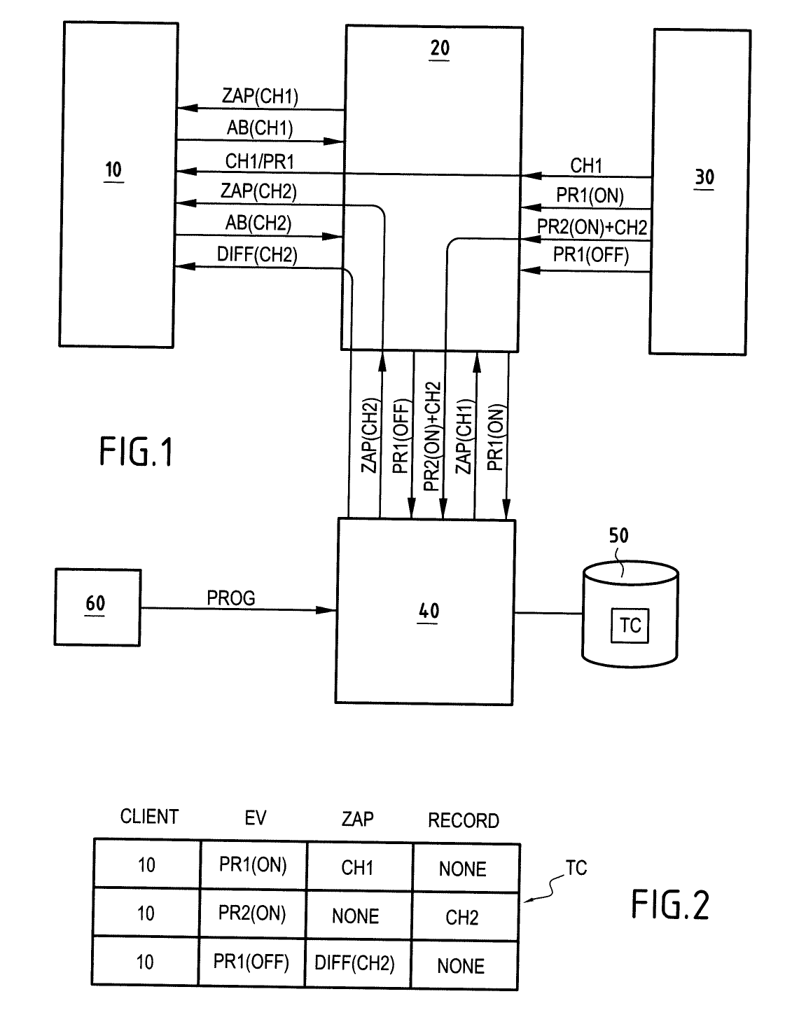

FIG. 1 represents a management system of the invention and a management method of the invention enabling a user to program a sequence of transmissions that he wishes to watch.

The system essentially comprises a network equipment 20 and a server 40 connected to a database 50.

The network equipment 20 can set up a call between an audiovisual program source 30 and receivers 10 over an IP network that is not shown.

The source 30 is also known as the network head end.

The receivers 10 are set top boxes, for example.

If a user of a terminal 10 wishes to receive an audiovisual program CH1, he selects that program using his remote controller and the receiver 10 sends the network equipment 20 a subscription request AB(CH1) including the identifier CH1 of the audiovisual program.

In response to this request AB(CH1), the network equipment adds the address of the receiver 10 to the multicast group for the audiovisual program CH1 broadcast by the source 30.

According to the invention, the user of the receiver 10 can program a sequence of transmissions that he wishes to view that are broadcast successively or simultaneously on different channels or in time periods that overlap at least in part. Thus the user can program a personalized chart of his evening's viewing by accessing an interactive portal 60, for example.

The interactive portal 60 interprets this programming as a succession of zappings conditional on the end of a transmission. It sends a list of these conditions to the server 40, which stores them in its database 50, in order to manage recording of transmissions that the user cannot view live and broadcasting of transmissions requested by the user in accordance with time constraints set in his program chart.

To implement this scenario, the management system of the invention is configured using a configuration table TC shown in FIG. 2.

This table includes:
a first column storing an identifier of the receiver concerned;
a second column storing events PRi(ON) and PRi(OFF) respectively corresponding to the start and to the end of the transmission PRi of an audiovisual program CHi;
a third column storing audiovisual programs that must be broadcast or sent to the receiver of the network on detection of the associated event in the first column; and
a fourth column specifying audiovisual programs that the management system of the invention must record on detection of the event in the first column.

The configuration table TC can be sent to the server 40 by the portal 60 during a preliminary phase PROG in which the user programs the management system of the invention.

This programming step primarily specifies in the configuration table TC a number of events and associated actions.

In the example described here, on reception of this configuration table TC, the server 40 stores it in the database 50.

The configuration table TC must be interpreted as follows:
If the server 40 of the invention detects the event PR1(ON), it must force broadcasting of the audiovisual program CH1 to the receiver 10, there being no need to record it.

The event PR1(ON) corresponds to the start of the transmission PR1 of the audiovisual program CH1, and is sent to the server 40 by the source 30 in the form of information in the broadcast stream of the channel CH1.

The second line of the configuration table TC shows that the management system of the invention must start to record the audiovisual program CH2 when the source 30 sends an event PR2(ON) representing the start of the transmission PR2 in the audiovisual program CH2.

Finally, the third line of the configuration table TC must be interpreted by the management device of the invention as indicating that it is to send the audiovisual program CH2 to the client 10 off-line when the server 40 receives a message PR1(OFF) from the source 30 representing the end of the transmission PR1 of the audiovisual program CH1.

Accordingly, when the transmission PR1 of the audiovisual program CH1 starts, the source 30 sends the server 40 a message PR1(ON) via the network equipment 20.

According to the configuration table, the server 40 then sends the receiver 10 a message ZAP(CH1) via the network equipment 20 to force broadcasting of the audiovisual program CH1 to the receiver 10.

In the embodiment described here, this message ZAP(CH1) is an SMNP frame that encapsulates the IGMP AB(CH1) command.

On reception of this message, the receiver 10 automatically sends a subscription request AB(CH1) to the network equipment that is to be subscribed to the audiovisual program CH1 broadcast by the source 30.

The person skilled in the art will understand that this request is sent automatically through the advantageous use of the SMNP to send the message to the receiver 10.

On reception of the subscription request AB(CH1), the management device of the invention subscribes the receiver 10 to the broadcast group for the audiovisual program CH1 so that the receiver can receive the program. To be more precise, the network equipment 20 adds the identifier of the receiver 10 to the broadcast list for the audiovisual program CH1.

At the same time, in the example described here, the network equipment 20 sets up a communications channel with the server 40 on which the audiovisual program CH1 is broadcast.

When the transmission PR2 of the audiovisual program CH2 starts, the source 30 sends the server 40 via the network equipment 20 the message PR2(ON) representing the start of transmission and the audiovisual program CH2.

According to the second line of the configuration table TC, the server 40 starts to record the audiovisual program CH2 in a memory of the database 50.

When the transmission PR1 of the audiovisual program CH1 ends, the source 30 sends a message PR1(OFF) via the network equipment 20 representing the end of transmission.

The reception of this PR1(OFF) message constitutes the event in the third line of the configuration table TC.

Consequently, the server 40 sends the receiver 10 via the network equipment 20 a message ZAP(CH2) that triggers sending by the receiver 10 of a request AB(CH2) to subscribe to the audiovisual program CH2.

The server 40 can first request the client to confirm that they wish to change channel. The subscription request AB(CH2) is sent if the client terminal 10 approves this zapping instruction, either explicitly or tacitly. If not, the server 40 stops recording the audiovisual program CH2.

In the embodiment described here, the management system of the invention understands that it is not to subscribe the receiver 10 to the broadcast group of the audiovisual program CH2 but instead set up a communications channel between the receiver 10 and the server 40 for off-line broadcasting of the audiovisual program CH2 that has been being recorded in the database 50 since the start of the transmission PR2.

The invention proposes other possibilities for configuring the management system.

For example it is possible to specify in a configuration table that an audiovisual program is to be recorded or a message is to be sent to the client 10 after a predetermined delay associated with an event.

During the programming phase PROG effected by the user via the interactive portal 60, the user can be required to select only transmissions with times that can overlap within a limit (the duration of the sliding window) of the time shifting facility (for example 30 minutes).

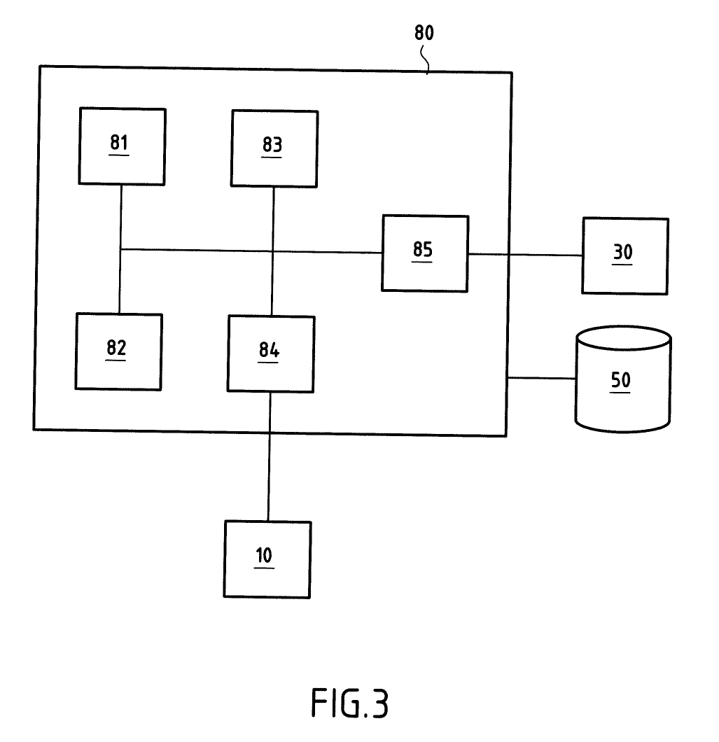

FIG. 3 represents a preferred embodiment of a computer of the invention.

The computer 80 combines in a single machine the functions of the network equipment 20 and the server 40 described with reference to FIG. 1.

The computer 80 includes a processor 81, a read-only memory (ROM) 82, and a random-access memory 83.

The read-only memory 82 stores a computer program of the invention, i.e. a program including instructions for executing the steps of the management method described above.

The computer 80 of the invention includes means 84 for setting up an IP call with the receiver 10.

The communication means 84 in particular send SNMP format ZAP messages to the receiver 10 and receive RTSP requests from the receiver.

The computer 80 of the invention also includes means 85 for receiving a video stream coming from the source 30 and directing such streams to the receiver 10.

Finally, the computer 80 of the invention can access a database 50 to store configuration tables of the same type as the table TC described above.

Note that the whole of the present document describes the sequencing of transmissions whereby the user begins by watching a live transmission and sequences to a second live transmission or an off-line transmission recorded beforehand.

The invention is not limited to such embodiments, of course, and applies to all possible ways to sequence transmissions. In particular, the user's chart of programs could correspond to a sequence comprising only recorded transmissions (for example transmissions recorded during the day for viewing in the evening), which are therefore all viewed off-line.

This would also enable the user to watch a first off-line transmission recorded beforehand and then to sequence to one or more live transmissions. Reciprocally, the user could start by watching a transmission live and then sequence to one or more off-line transmissions. In other words, the system of the invention and the method of the invention cater for all configurations for sequencing live and off-line transmissions.

1. A system for managing audiovisual programs in a telecommunications network, each audiovisual program being broadcast by a source to receivers that are subscribed to a broadcast group, the management system comprising:
means for interpreting a sequence of transmissions of audiovisual programs programmed by a user of a receiver in the form of a succession of commands to change program, a command to change program being conditional on a preceding program in said sequence ending;
means for detecting a predetermined event corresponding to the start of the first transmission in the sequence, or to the end of one of said transmissions in the sequence; and
means for sending said receiver, after said event is detected, a first message adapted to trigger sending by said receiver to said management system of a first request to subscribe to a broadcast group for the first audiovisual program in the sequence, or the audiovisual program of the transmission in said sequence following the transmission for which the end has been detected.

2. A management system according to claim 1, further comprising:
means for detecting a predetermined event corresponding to the start of a transmission of one of said programs in the sequence; and
means for recording said audiovisual program broadcast in said network in a sliding time window, after said event is detected, if the end of the preceding program in said sequence has not yet been detected.

3. A management system according to claim 2, wherein, after detection of the end of a transmission of one of said programs in the sequence, said means for sending said receiver a first message also send said receiver a second message adapted to trigger sending by said receiver to said management system of a request to set up a communications channel with said management system to obtain, in said channel, at least part of the audiovisual program recorded by said system and corresponding to the program of the transmission after the transmission for which the end has been detected.

4. A method of managing audiovisual programs in a telecommunications network, each program being broadcast by a source to receivers that are subscribed to a broadcast group, said management method comprising:
interpreting a sequence of transmissions of audiovisual programs programmed by a user of a receiver in the form of a succession of commands to change program, a command to change program being conditional on a preceding transmission in said sequence ending;
detecting a predetermined event corresponding to the start of the first transmission in the sequence, or to the end of one of said programs in the sequence; and
sending said receiver, after said event is detected, a first message adapted to trigger sending by said receiver of a first request to subscribe to a broadcast group for the first audiovisual program in the sequence, or the audiovisual program of the transmission in said sequence following the transmission for which the end has been detected.

5. A management method according to claim 4, further comprising, before said sending step, a step of confirming subscription of said receiver to said broadcast group.

6. A management method according to claim 4, characterized in that it includes:
step of detecting a predetermined event corresponding to the start of a transmission of one of said programs in the sequence; and
recording said audiovisual program broadcast in said network in a sliding time window, after said event is detected, if the end of the preceding transmission in said sequence has not yet been detected.

7. A management method according to claim 6, wherein, after detection of the end of one of said programs in the sequence, said step of sending said receiver a message sends said receiver a second message adapted to trigger sending by said receiver to said management system of a second request to set up a communications channel with said management system to obtain, in said channel, at least part of the audiovisual program recorded by said system and corresponding to the transmission in said sequence after the transmission for which the end has been detected.

8. A computer program including instructions for executing the steps of the management method according to claim 4 when said program is executed by a computer.

9. A computer-readable storage medium on which is stored a computer program including instructions for executing the steps of the management method according to claim 4.
